(19) United States
(12) Patent Application Publication
(10) Pub. No.: US 2011/0082667 A1
(43) Pub. Date: Apr. 7, 2011

(54) SYSTEM AND METHOD FOR VIEW-DEPENDENT ANATOMIC SURFACE VISUALIZATION

(75) Inventors: Julian Ibarz, Plainsboro, NJ (US); Liron Yatziv, Fremont, CA (US); Norbert Strobel, Heroldsbach (DE)

(73) Assignee: Siemens Corporation, Iselin, NJ (US)

(21) Appl. No.: 12/875,191

(22) Filed: Sep. 3, 2010

Related U.S. Application Data
(60) Provisional application No. 61/249,014, filed on Oct. 6, 2009.

(51) Int. Cl. G06F 17/50

(52) U.S. Cl. 703/1

(57) ABSTRACT

A method for simultaneous visualization of the outside and the inside of a surface model at a selected view orientation includes receiving a digitized representation of a surface of a segmented object, where the surface representation comprises a plurality of points, receiving a selection of a viewing direction for rendering the object, calculating an inner product image be calculating an inner product \vec{n}ₚ·\vec{d} at each point on the surface mesh, where \vec{n}ₚ is a normalized vector representing the normal direction of the surface mesh at a point p towards the exterior of the object and \vec{d} is a normalized vector representing the view direction, and rendering the object using an opacity that is a function of the denoised inner product image to yield a rendered object, where an interior of the object is rendered.

### CROSS REFERENCE TO RELATED UNITED STATES APPLICATIONS

This application claims priority from “View-depended Anatomic Surface Visualization”, U.S. Provisional Application No. 61/249,014 of Ibarz, et al., filed Oct. 6, 2009, the contents of which are herein incorporated by reference in their entirety.

### TECHNICAL FIELD

This disclosure is directed to methods of visualizing surface models of an anatomical structure.

### DISCUSSION OF THE RELATED ART

Many clinical applications use surface rendering of anatomic structures to allow clinical staff to view and interact with the data for interventional and diagnostic purposes. Surfaces involved are usually generated using imaging modalities such as computed tomography (CT), magnetic resonance imaging (MRI), or C-arm CT. In some cases, however, it is useful for a physician to not only see the outside but also view the inside of a surface model. This is to either study the internal shape or view additional graphics that are placed on the inside of the surface. For example, treatment of atrial fibrillation (Afib) by radiofrequency catheter ablation (RFCA) may involve a 3D surface of the left atrium (LA). The goal of RFCA of Afib is to electrically isolate the pulmonary veins (PVs) from the LA by placing ablation lesions at certain positions. RFCA is usually performed under X-ray fluoroscopy guidance. However, X-ray fluoroscopy does not depict the LA and PVs well, because the LA and PVs are made up of soft-tissue. Thus, it is advantageous to augment live fluoroscopy images with a perceptively rendered 3D surface representation of the LA. In addition, to effectively navigate during an RFCA procedure, it is useful to view the inside of the LA.

However, viewing through a closed opaque surface is a challenge. Clipping tools have been developed to address this. Medical workstations typically provide object-aligned clipping planes, but it is also possible to compute view-aligned clipping planes. Typically, many clipping planes are possible to give the user flexibility. Object-aligned clipping planes are not view dependent, in that the clip is attached to the surface and moves with it when the view direction is changed. So if a user wants to view the inside of the surface from another direction, the user will need to do two things: first, change the view point; and second, re-adjust the position of the clipping plane according to the new view. Even view-aligned clipping planes pose a challenge, by restricting the orientation of the clipping plane. However, a user may still need to select the actual position of the clipping plane. In sum, either clipping method requires some user interaction.

Making a surface semi-transparent is also a common method to view the inside of a model. To this end, a user can adjust the transparency of the surface to blend internal graphics on the inside of the surface inside and other graphics objects placed in the interventional context, e.g., catheters, with the external surface. However, since the graphics are blended, the internal graphics and the external graphics are not clearly distinguishable. There is a tradeoff. High transparency allows seeing inside a surface model, while high opacity results in a better rendering of the outside of the surface.

Using an endoscopic to view the inside of a surface model is another option. In this case, the camera is actually placed inside the surface. This lets a user see the inside rather than the outside of the surface. While this might be a solution for some applications, in many cases it is preferable to view the surface with the camera placed outside. For example, to support augmented fluoroscopy, the camera must be aligned with the position of the X-ray source, which is outside of the patient.

One publication about view-dependent visualization, that of Weiskopf, Diepstraten, and Ertl (2002), was dependent on the size of the mesh and not directly related to the surface of the mesh. Another publication about volume visualization, that of Bruckner, Grimm, Kanitsar, and Groeller (2005), changes the transparency of a voxel as a function of the gradient of a volume, not a normal of a surface, but uses a complex method and is directed to volume rendering. Another publication, that of Kruger, Schneider, and Westermann (2006), discloses organ surface visualization and can be used for mesh visualization, but does not disclose the use of a dot product between the normal of the surface of the mesh and the view direction or the need for denoising the normals.

### SUMMARY OF THE INVENTION

Exemplary embodiments of the invention as described herein generally include methods and systems for simultaneous visualization of the outside and the inside of a surface model at a selected view orientation. A method according to an embodiment of the invention allows simultaneous visualization of the outside and the inside of a surface model at a selected view orientation, by placing a camera outside of the surface, and by automatically displaying the surface in a way that attempts to predict how medical staff personnel would like to see it. This personalized display of a surface according to an embodiment of the invention is referred to herein as a carving, or a carved rendering. A method according to an embodiment of the invention is view-aligned, being based on the angle between the normal vector at the surface and the camera view direction, and can adapt to both view direction and the local surface shape. A carving update can be computed in real-time that adjusts to a new view direction. A method according to an embodiment of the invention allows the user to obtain a 3D perspective of surface from the outside, and by using a simple segmentation threshold, can reveal as much of the internal surface and graphics as desired. This way, users can tune the technique to match their specific needs. Unlike clipping tools, carving is not bound to some predefined shape of the clipping tool (typically a plane). Instead, carving depends on the local curvature of the surface and its orientation with respect to the viewing direction. A method according to an embodiment of the invention does not necessarily use semi-transparency, so graphic blending is not required. A method according to an embodiment of the invention can facilitate a change of opacity or remove parts of the surface to reveal anatomical details on the inside in the back of the surface (“back surface”), which can enhance the user's understanding of a patient's anatomy. A method according to an embodiment of the invention can support carving of the front face of an object, carving of the back face of an object, or any combination thereof.

A method according to an embodiment of the invention is intuitive and automatic allowing medical staff to use it without prior training or experience, and has no noticeable negative impact on performance. A method according to an embodiment of the invention can be used together with existing clipping tools, and it can also be combined with methods to change surface transparency. In addition, a method according to an embodiment of the invention can generate carved 3D data sets for augmenting live fluoroscopic images. Finally, a method according to an embodiment of the invention can be implemented on a GPU.

According to an aspect of the invention, there is provided a method for simultaneous visualization of the outside and the inside of a surface model at a selected carving orientation, the method including receiving a digitized representation of a surface of a segmented object, where the surface representation comprises a plurality of points, receiving a selection of a carving direction for rendering the object, calculating an inner product image by calculating an inner product \vec{n}ₚ·\vec{d} at each point on the surface mesh, where \vec{n}ₚ is a normalized vector representing the normal direction of the surface mesh at a point p towards the exterior of the object and \vec{d} is a normalized vector representing the carving direction, and rendering the object using an opacity that is a function of the inner product image to yield a rendered object, where an interior of the object is rendered.

According to a further aspect of the invention, the opacity is defined as

$$opacity ( p ) = \{ \begin{matrix}{{n}^{->}}_{p} \cdot {d}^{->} \leq c : 0 , \\ {{n}^{->}}_{p} \cdot {d}^{->} > c : 1 ,\end{matrix}$$

where c is a predetermined threshold that determines where the carving is performed on the surface

According to a further aspect of the invention, the opacity is defined as

$$opacity ( p ) = \{ \begin{matrix}1 , & if {{n}^{->}}_{p} \cdot {d}^{->} \leq 0 , \\ {clamp}_{[ 0 , 1 ]} [ 1 - α ( \frac{2 a sin ( {{n}^{->}}_{p} \cdot {d}^{->} )}{π} - c ) ] t , & otherwise ,\end{matrix}$$

where the clamp operator clamps opacity values to be between 0 and 1, c is a predetermined parameter that controls where transition between opaqueness and transparency starts, α is a predetermined parameter that controls the speed of change between opaque and fully transparent, and t is the opacity for the whole surface representation.

According to a further aspect of the invention, the method includes denoising the normal vectors of the surface representation by applying a low-pass filter to the inner product image.

According to a further aspect of the invention, the method includes registering the rendered object to a patient, receiving a 2D image of the object from the patient, overlaying rendered object onto the 2D image of the object, and displaying the overlaid image.

According to a further aspect of the invention, the surface is represented as a triangular mesh.

According to a further aspect of the invention, the carving direction is a view direction.

According to another aspect of the invention, there is provided a method for simultaneous visualization of the outside and the inside of a surface model at a selected carving orientation, the method including receiving a digitized representation of a surface of a segmented object, where the surface representation comprises a plurality of points, calculating \vec{n}ₚ·\vec{d} at each point on a front of the surface representation to yield a back face culled inner product image, where \vec{n}ₚ is a normalized vector representing the normal direction of the surface representation at a point p towards the exterior of the object and \vec{d} is a normalized vector representing a carving direction, calculating \vec{n}ₚ·\vec{d} and a depth at each point on a back of the surface representation to yield a front face culled inner product image and a front face depth, receiving a color buffer and a depth buffer of a rendered scene, blending the back face culled inner product image with the rendered scene using the opacity function to yield a partially blended scene, and blending the front face culled inner product image with the partially blended scene using the opacity function to yield a fully blended scene.

According to a further aspect of the invention, the method includes calculating a depth at each point on the front of the surface representation to yield a back face depth, using the back face depth to match the back face culled inner product image to the rendered scene, calculating a depth at each point on the back of the surface representation to yield a front face depth, and using the front face depth to match the front face culled inner product image to the partially blended scene.

According to a further aspect of the invention, the back face is colored with a first color when it is blended with the scene, and the front face is colored with a second color when it is blended with the scene.

According to a further aspect of the invention, the opacity is defined as

$$opacity ( p ) = \{ \begin{matrix}{{n}^{->}}_{p} \cdot {d}^{->} \leq c : 0 , \\ {{n}^{->}}_{p} \cdot {d}^{->} > c : 1 ,\end{matrix}$$

where c is a predetermined threshold.

According to a further aspect of the invention, the opacity is defined as

$$opacity ( p ) = \{ \begin{matrix}1 , & if {{n}^{->}}_{p} \cdot {d}^{->} \leq 0 , \\ {clamp}_{[ 0 , 1 ]} [ 1 - α ( \frac{2 a sin ( {{n}^{->}}_{p} \cdot {d}^{->} )}{π} - c ) ] t , & otherwise ,\end{matrix}$$

where the clamp operator clamps opacity values to be between 0 and 1, c is a predetermined parameter that controls where transition between opaqueness and transparency starts, α is a predetermined parameter that controls the speed of change between opaque and fully transparent, and t is a global opacity.

According to a further aspect of the invention, the carving direction is a view direction.

According to another aspect of the invention, there is provided a program storage device readable by a computer, tangibly embodying a program of instructions executable by the computer to perform the method steps for simultaneous visualization of the outside and the inside of a surface model at a selected view orientation.

### BRIEF DESCRIPTION OF THE DRAWINGS

FIG. 1 depicts a mesh segmentation of a heart a CT image volume, according to an embodiment of the invention.

FIG. 2 depicts a direction image of the heart, based on the view direction vector \vec{d} at each point p, according to an embodiment of the invention.

FIG. 3 depicts a mesh image of the heart that has been carved without edge smoothing, according to an embodiment of the invention.

FIG. 4 depicts a direction image using smoothed surface normals, according to an embodiment of the invention.

FIG. 5 depicts a mesh that has been carved with edge smoothing, according to an embodiment of the invention.

FIG. 6 depicts a smoothly carved mesh combined with a global transparency, according to an embodiment of the invention.

FIG. 7 depicts a carved surface representation for augmenting a live fluoroscopy image, according to an embodiment of the invention.

FIG. 8 is a flowchart of a method for simultaneous visualization of the outside and the inside of a surface model at a selected view orientation, according to an embodiment of the invention.

FIG. 9 is a flowchart of a method for simultaneously visualizing a transparent surface model at a selected view orientation with opaque objects, according to an embodiment of the invention.

FIG. 10 is a block diagram of an exemplary computer system for implementing a method for simultaneous visualization of the outside and the inside of a surface model at a selected view orientation, according to an embodiment of the invention.

### DETAILED DESCRIPTION OF EXEMPLARY EMBODIMENTS

Exemplary embodiments of the invention as described herein generally include systems and methods for simultaneously visualizing the outside and the inside of a surface model at a selected view orientation. Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

As used herein, the term “image” refers to multi-dimensional data composed of discrete image elements (e.g., pixels for 2-D images and voxels for 3-D images). The image may be, for example, a medical image of a subject collected by computer tomography, magnetic resonance imaging, ultrasound, or any other medical imaging system known to one of skill in the art. The image may also be provided from non-medical contexts, such as, for example, remote sensing systems, electron microscopy, etc. Although an image can be thought of as a function from R³ to R or R⁷, the methods of the inventions are not limited to such images, and can be applied to images of any dimension, e.g., a 2-D picture or a 3-D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

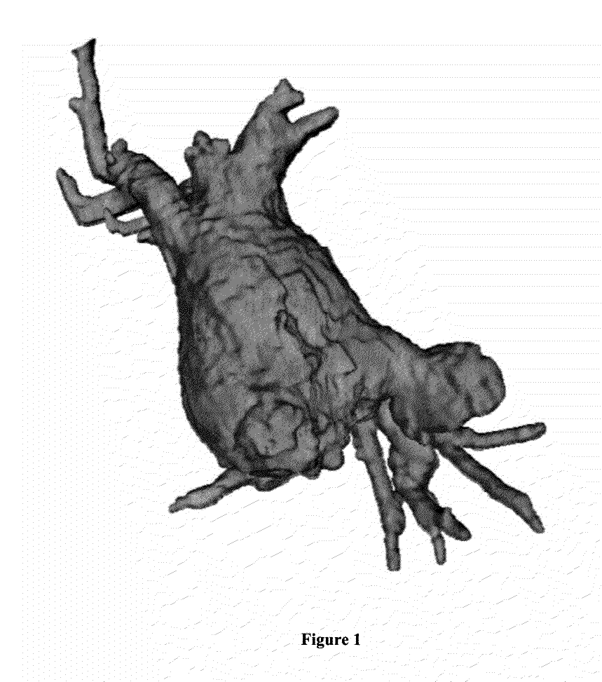

An exemplary, non-limiting clinical workflow for a method according to an embodiment of the invention includes: (1) loading or generating a polygon mesh representing the surface of an object; and (2) allowing the system or the user to select the desired view direction and update the view. A 3-D viewing camera is defined by explicitly specifying where (the direction, the view direction) the camera is looking, and this direction is used for carving. Since a physician has already defined the 3-D camera, a view directed carving according to an embodiment of the invention does not request new parameters, except for a transparency threshold and speed, which is done once. Thus a user does not need to select a viewing direction. The mesh visualization updates automatically based on a new view direction. The user may change either manually or automatically one or more parameters of the visualization method, such as a segmentation threshold. When a polygon mesh is not required, the user can remove or hide the mesh. An exemplary, non-limiting mesh segmentation of a heart taken from a CT image volume is depicted in FIG. 1.

Rasterization is the task of taking a high-level representation of an image and converting it into a raster image (pixels or dots) for output on a video display or printer, or for storage in a bitmap file format. A high level representation may be a may be a polygon mesh, or a parameterized surface such as a B-spline. In any case, a digitized surface representation will comprise a set of discrete points that approximate the surface. A discussion of rasterization may be found at http://en.wikipedia.org/wiki/Rasterisation, from which the following description is derived. Current rasterization programs are typically written to interface with a graphics API, which drives a dedicated GPU.

Rasterization takes a 3D scene, typically represented as polygons, and renders it onto a 2D surface, typically displayed by a computer monitor. Polygons are themselves represented as collections of triangles. Triangles are represented by 3 vertices in 3-D space. A rasterizer then takes a stream of vertices, transforms them into corresponding 2-dimensional pixels that correspond to monitor's display, and fills in the transformed 2-dimensional triangles as appropriate.

Transformations are usually performed by matrix multiplication. The main transformations are translation, scaling, rotation, and projection. In order to represent translation by matrix multiplication, a 3 dimensional vertex may be transformed into 4 dimensions by augmenting an extra variable, known as a “homogeneous variable”. The resulting 4-component vertex may then be left multiplied by 4×4 transformation matrices. A series of translation, scaling, and rotation matrices can logically describe most transformations. Rasterization systems generally use a transformation stack that stores matrices to move the stream of input vertices into place.

As an example, consider a stream of vertices that form a model that represents an object. First, a translation matrix would be pushed onto the stack to move the model to the correct location. A scaling matrix would be pushed onto the stack to size the model correctly. One or more rotation matrices about the appropriate axes would be pushed onto the stack to orient the model properly. Then, the stream of vertices representing the object would be sent through the rasterizer.

After all points have been transformed to their desired locations in 3-space with respect to the viewer, they must be transformed to the 2-D image plane. Since real world images are perspective images, with distant objects appearing smaller than objects close to the viewer, a perspective projection transformation is applied to these points. A perspective transformation transforms a perspective viewing volume into an orthographic viewing volume. The perspective viewing volume is a truncated pyramid, while the orthographic viewing volume is a rectangular box, where both the near and far viewing planes are parallel to the image plane. A perspective projection transformation can be represented by a 4×4 matrix that is a function of the distances of the far and near viewing planes. The resulting four vector will be a vector where the homogeneous variable is not 1. Homogenizing the vector, or multiplying it by the inverse of the homogeneous variable such that the homogeneous variable becomes unitary, provides the resulting 2-D location in the x and y coordinates.

The final step in the traditional rasterization process is to convert the triangles defined by the resulting 2-D vertices into pixels, and then to fill in the pixels in the image plane. One issue is whether to draw a pixel at all. This is a special case of hidden surface determination, the process of determining which surfaces and parts of surfaces are not visible from a certain viewpoint. For a pixel to be rendered, it must be within a triangle, and it must not be occluded, or blocked by another pixel. There needs to be a way of ensuring that pixels close to the viewer are not overwritten by pixels far away.

A z buffer, also known as a depth buffer, is a common solution. The z buffer is a 2D array corresponding to the image plane which stores a depth value for each pixel. Whenever a pixel is drawn, it updates the z buffer with its depth value. During rasterization, the depth/Z value of each pixel is checked against the existing depth value. If the current pixel is behind the pixel in the Z-buffer, the pixel is rejected, otherwise it is shaded and its depth value replaces the one in the Z-buffer. This ensures that closer pixels are drawn and farther pixels are disregarded.

Images acquired from a patient using, for example, X-rays, would typically be grey level images without color. In this case, the opacity of a pixel corresponding to an object or organ being displayed would take a default value of 1. The color of a pixel would then be a false color determined based on highlighting considerations, that is, by how best to present the object in the rendered 2-D image.

A number of acceleration techniques have been developed over time to remove or cull out objects which can not be seen, to minimize the number of polygons sent to the renderer. The simplest way to remove polygons is to cull all polygons which face away from the viewer. This is known as backface culling. Since a mesh is a hollow shell that encloses an object, the back side of some faces, or polygons, in the mesh will never face the camera. Polygons facing away from a viewer are always blocked by polygons facing towards the viewer unless the viewer is inside the object. Typically, there is no reason to draw such faces. Once a polygon has been transformed to screen space, its facing direction can be checked and if it faces the opposite direction, it will not be drawn. Front face culling can be similarly defined.

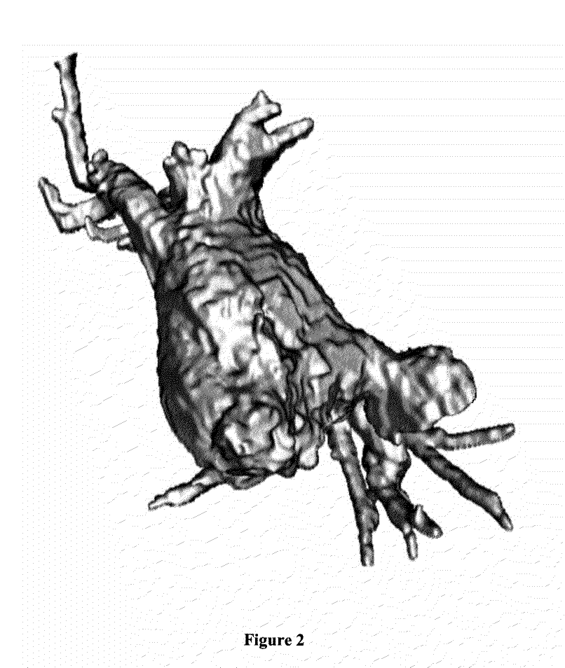

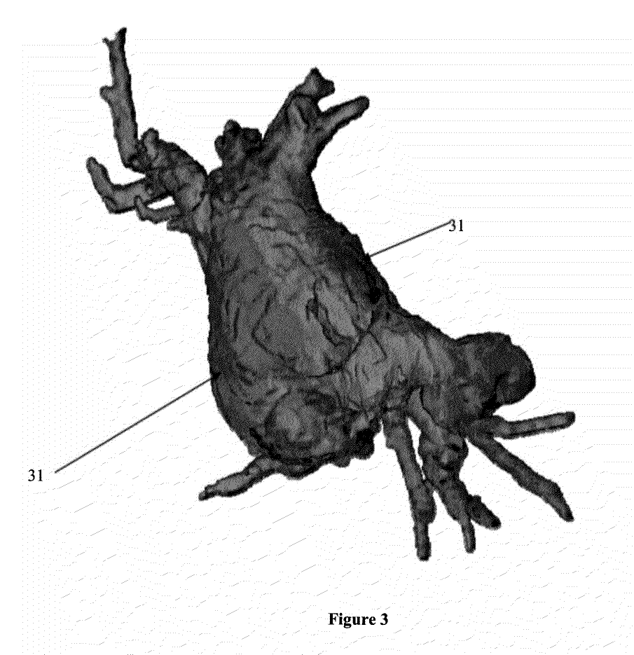

A method according to an embodiment of the invention is based on the opacity of surface points as a function of both the normal direction of the surface, towards the exterior of the anatomy, and a carving direction, which may be the view direction. For example, one exemplary, non-limiting form of the opacity function could be:

$$opacity ( p ) = \{ \begin{matrix}{{n}^{->}}_{p} \cdot {d}^{->} \leq c : 0 , \\ {{n}^{->}}_{p} \cdot {d}^{->} > c : 1 ,\end{matrix}$$

where opacity(p) is the opacity used for point p on the surface, \vec{n}ₚ is a normalized vector representing the normal direction of the surface at point p towards the exterior of the anatomy, and \vec{d} is a normalized vector representing the carving direction. FIG. 2 depicts a direction image of the heart, based on the view direction vector \vec{d} at each point p, according to an embodiment of the invention. In this example, c is a constant threshold that determines if a point on the surface is opaque or transparent depending on the inner product \vec{n}ₚ·\vec{d}. The threshold parameter c can be determined automatically or manually. For example, a surface point may be set to be either transparent or opaque. If a point is transparent a point of the inner surface behind it may appear depending on the opacity function. FIG. 3 depicts a possible result, where for better visualization the inner surface may have a different color, indicated by reference number 31 in the figure. In more complex scenarios, c could be a function of other variables. For example, c could depend on the depth of the point or on the scalar value of the point that is taken from a physical measure. The opacity function could be continuous rather than binary (opaque or transparent). A continuous opacity function allows more complex effects to be created, such as semi-transparency or smoothing the carving, rather than a sharp edge. An exemplary, non-limiting continuous opacity function is:

$$opacity ( p ) = \{ \begin{matrix}1 , & if {{n}^{->}}_{p} \cdot {d}^{->} \leq 0 , \\ {clamp}_{[ 0 , 1 ]} [ 1 - α ( \frac{2 a sin ( {{n}^{->}}_{p} \cdot {d}^{->} )}{π} - c ) ] t , & otherwise ,\end{matrix}$$

where the clamp operator clamps the values to be between 0 and 1, c is, as in the previous formula, the parameter that controls where transition between opaque and transparency starts, the parameter α controls the speed of change between opaque and fully transparent, and t is the opacity for the whole mesh, known as the global opacity. This allows the mesh to be somewhat transparent even if the surface transparency (or opacity, opacity=1-transparency) is unchanged. This opacity function can be efficiently implemented on a GPU using, for example, OpenGL and GLSL in a fragment shader. The opacity can be combined with color at the blending stage of the graphics pipeline.

If the carving direction is the view direction, the carving will change automatically if the view direction changes. In a dual plane setup, which has two X-ray cameras in two different directions that defines two X-ray planes, a user can control both carvings independently of their differing directions and can see the same object, such as the left atrium, with a different carving for the differing planes adapted to the view direction.

The result of an algorithm according to an embodiment of the invention on a segmentation of the heart of a CT volume is shown in FIG. 3. From this it can be seen that a segmented surface of an object can be rather noisy. As a result, the carving may be disturbed and many islands may be present that are not wanted. As part of an algorithm according to an embodiment of the invention, other calculation steps may be optionally used to achieve the desired results. These additional steps include preprocessing of the variables that enter the opacity function, such as de-noising the surface normals to achieve a smoother cut of the mesh, and processing the intermediate values, such as the inner product \vec{n}ₚ·\vec{d}. Those steps can be performed on-the-fly or calculated in advance.

On-the-fly smoothing step: Prior to calculating the opacity of points on the surface, it is beneficial to use denoising techniques. These denoising techniques can, for example, be applied to a temporary inner product (\vec{n}ₚ·\vec{d}) image, or to a buffer after each creation of the inner product image. This inner product image represents the value of the inner product for each visible point on the original surface. Various existing image denoising techniques can be applied to this task. Since the image is camera-view depended, the denoising needs to be performed each time the view changes, and is thus performed “on-the-fly”. For example, low-pass filters, such as the well-known mean/median/Gaussian filters, can be used to smooth the image. Depending on the structure of the anatomy, edges may need to be preserved (edges may be created by vessels on top of the left atrium surface, thus a naive denoising can smooth the edges with the left atrium, creating confusion: a user might not correctly distinguish the vessels from the left atrium), therefore smoothing techniques need to take edges into account. For example, cross-bilinear filtering using the depth buffer as the edge image is a fast technique that can perform edge-preserving smoothing. In general, on-the-fly smoothing can be an option with hardware that can quickly perform the re-computation. Whether to use on-the-fly smoothing may also depend on the size of the smoothed image. In certain scenarios, on-the-fly smoothing could be the more efficient solution, such as when a 3D surface changes with time. In general, however, the on-the-fly approach may lose information about the shape of the surface, such as with the vessel on top of the left atrium situation, because it is based on a 2D image rather than on the 3D shape of the surface.

Preprocessing smoothing step: This step may be more efficient than “on-the-fly” smoothing, since the surface normals need only be processed once at the beginning of the procedure (as long as the surface does not change). In other words, the normals need not be smoothed again when the view changes. The smoothed normals need not necessarily replace the original normals. Instead, the smoothed normals can be stored in memory separately from the original unsmoothed normals to avoid affecting the visualization of the remaining surface. This way, the visible surface retains its details. The whole surface, rather than a projection image, may be processed in many cases, to take into account the 3D characteristics of the surface during the smoothing operation.

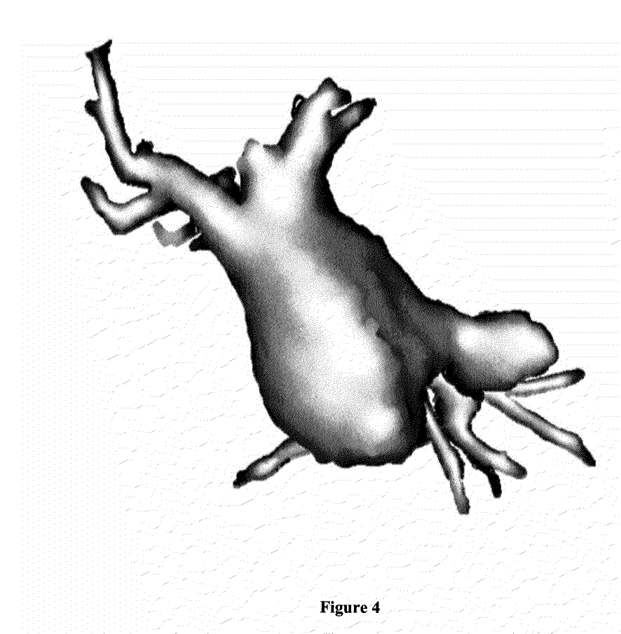

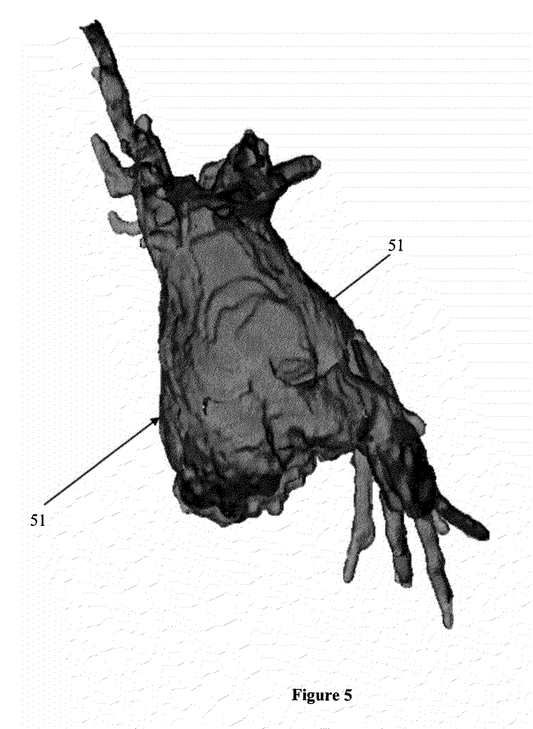

An exemplary smoothing technique according to an embodiment of an invention smoothes the normals of the polygons comprising the mesh using a low-pass filter that is iteratively applied to the mesh. The result of this filtering is depicted in FIG. 4, which depicts a direction image with smoothed normals. To compute the final output, the smoothed normals can be used to determine where to carve, and the actual normals can be used to display the surface details for the remaining parts of the surface. FIG. 5 depicts a mesh that has been carved with edge smoothing, with the inner surface indicated by reference number 51 in the figure.

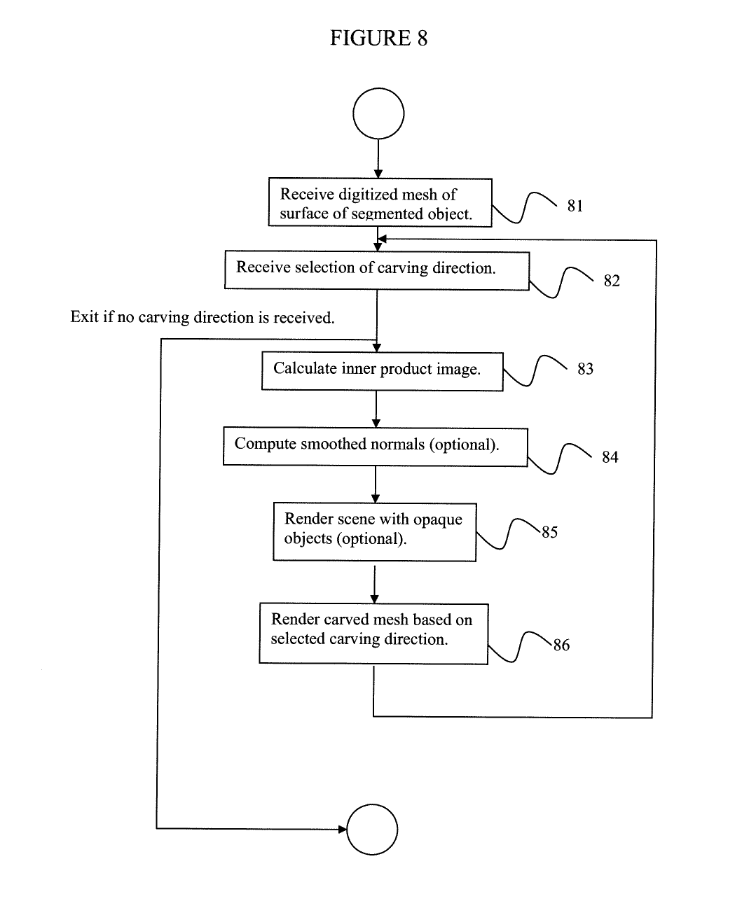

A flowchart of a method for simultaneously visualizing the outside and the inside of a surface model at a selected view orientation is depicted in FIG. 8. Referring now to the figure, a method according to an embodiment of the invention starts at step 81 by receiving a representing of the surface of a segmented object in a digitized image. According to an embodiment of the invention, the representation may be a polygon mesh, however, in other embodiments of the invention, other representations, such as parameterized surfaces, or a B-spline, may be used. At step 82, a selection of a view direction is received. If no view direction is received, a method according to an embodiment of the invention may exit, or use a non-view direction based carving direction. If a view direction has been selected, or a carving direction has been defined, then, at step 83 an inner product image is calculated by calculating an inner product \vec{n}ₚ·\vec{d} at each point on the surface mesh, where \vec{n}ₚ is a normalized vector representing the normal direction of the surface mesh at a point p towards the exterior of the object and \vec{d} is a normalized vector representing the view direction. The normal vectors of the inner product image may be smoothed by denoising, as described above, at step 84. According to other embodiments of the invention, step 84 may be omitted. At step 85, if the rendered mesh is to be overlayed with another image, such as a fluoroscopic X-ray image, opaque objects in the image may be combined with the mesh. According to other embodiments of the invention, step 85 may be omitted. The mesh is rasterized and rendered at step 86 using one of the opacity functions disclosed above. According to an embodiment of the invention, shading may be performed after the opacity has been calculated. An exemplary, non-limiting shading algorithm is the Phong algorithm. A method according to an embodiment of the invention then returns to step 82 to select another view direction selection.

When implementing a visualization method according to an embodiment of the invention, the smoothed direction image can be drawn in a texture, for example by using Frame Buffer Objects in OpenGL. The smoothed direction image can then be used in a second rendering pass to carve the mesh to produce the final visualization result.

When saving or loading a mesh, the original normals and the smoothed normals can be saved and loaded with the mesh.

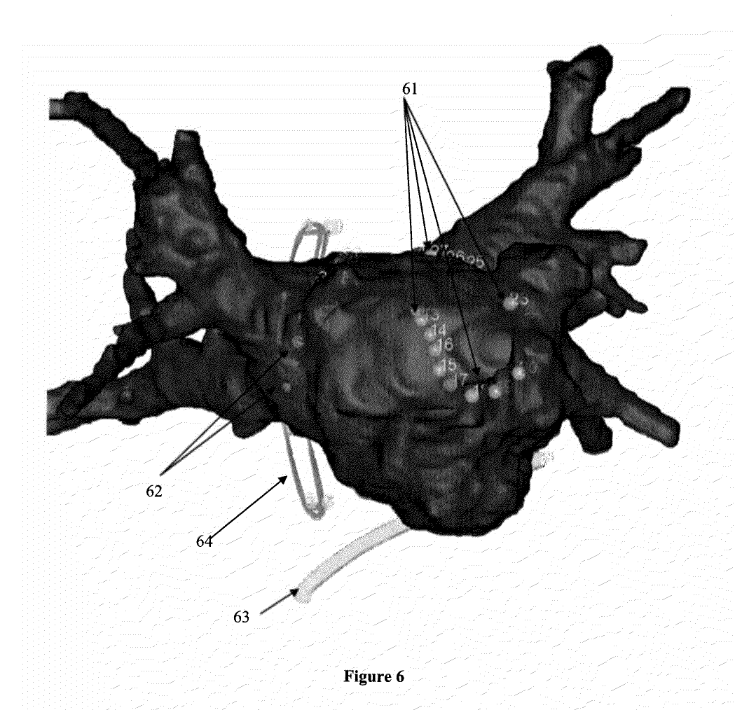

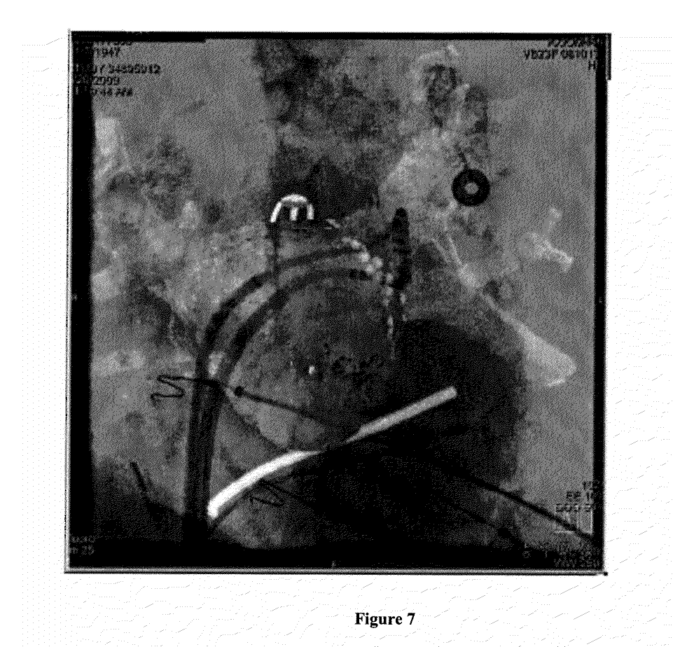

Overlay visualization for augmented fluoroscopy: Since live X-ray fluoroscopy images do not display soft-tissue details well, the carved 3D surfaces can be used to augment them. Assuming that the 3D data set has been registered to the patient, the carved 3D surfaces are rendered under the same perspective geometry the C-arm system uses to acquire the fluoro projections. The carving result and the fluoro projection are then blended to produce a combined image. An example of a smoothly carved mesh blended with a globally transparent image is shown in FIG. 6, which depicts a mono-plane situation. The dots 61 and 62 represent ablations in need of catheters. The thick curved line 63 in the lower part of the image is a catheter, while the ellipse-like curve 64 behind the heart is the esophagus. This blending of a carved image may also be applied to biplane imaging scenarios. In this case, the carved 3D surface is rendered twice: under the view direction of plane A and plane B, respectively. Then each rendering is used to augment the associated live fluoroscopy image. FIG. 7 depicts another carved surface representation for augmenting a live fluoroscopy image, according to an embodiment of the invention.

Combination of carving and semi-transparency to show hidden objects, such as the esophagus: In some cases, additional 3D objects are present behind the carved result, such as a graphical model representing the esophagus. In this case, it may be beneficial to have a global transparency on the mesh in addition to the transparency “performed” by the carving. This effect can be achieved using the opacity function given before. However, when performing transparency on the whole mesh, artifacts may appear when using existing blending techniques. This effect may be removed using depth peeling, but this technique is computationally expensive and provides more realism than necessary.

A challenge in rendering transparent triangles using depth buffers is that one needs to keep the previous triangles and blend them with the current triangles. However, current rasterizer engines cannot guarantee drawing the triangles in an order that ensures that triangles far away will be drawn before triangles closer to the camera. In addition, the order of blending gives different results. That is, blending the closest triangle first or last will yield different rendering results. In mathematical terms, blending is not commutative in that one cannot commute the blending order the closest triangles with the farthest triangles. Thus, the triangles need to be sorted in a z-order.

Since the depth-buffer keeps only the closest triangle, it is generalized to keep the N closest triangles, in a process known as depth peeling. Depth peeling has this workflow: (1) Render the geometry in the color/depth buffer, but configure the z-buffer in greater-only filtering, to keep only triangle/fragments with the greatest z; (2) Copy the depth buffer into a texture; and (3) For i=1, . . . , N, render and blend the geometry in the color/depth buffer with the previous rendering only if the fragment depth is less than that of the pixel from the depth texture generated from the previous rendering, but keep the z-buffer configured as greater only filtering, to keep the i+1 farthest triangle on a pixel. This workflow requires N iterations to blend and sort the N closest triangle intersections with a pixel.

A peeling algorithm according to an embodiment of the invention, referred to herein below as culling peeling, keeps only the two closest triangles, because after blending the two triangles, other triangles will have essentially no impact on the final rendering result, and uses two rendering passes of the geometry (two rasterisations), as follows: (1) Configure the z-buffer to be less-only, to keep only the closest triangles; (2) Render once with only the back faces only (front face culling) and blend with the previous scene/opaque rendering stored in the color/depth buffers; (3) Render a second time with only the front faces (back face culling) and blend with the previous scene/opaque rendering stored in the color/depth buffers. The sorting is implicit due to the nature of the back and front faces, as the back faces are usually always farthest from the front faces, at least for real objects such as organs that are to be displayed. Denoising steps may be included if necessary. To help a physician distinguish the front inside surface and back inside surface, different colors or shading materials may be applied.

A culling peeling algorithm according to an embodiment of the invention is faster than depth peeling because (1) no depth copy is performed for the second iteration, and (2) the previous depth buffer value is not accessed for sorting since there is no sorting and the use of front/back face culling during the rendering (which is disabled in depth peeling) generally permits dividing by two the number of triangles being rasterized, thus almost doubling the speed of the rendering for each pass.

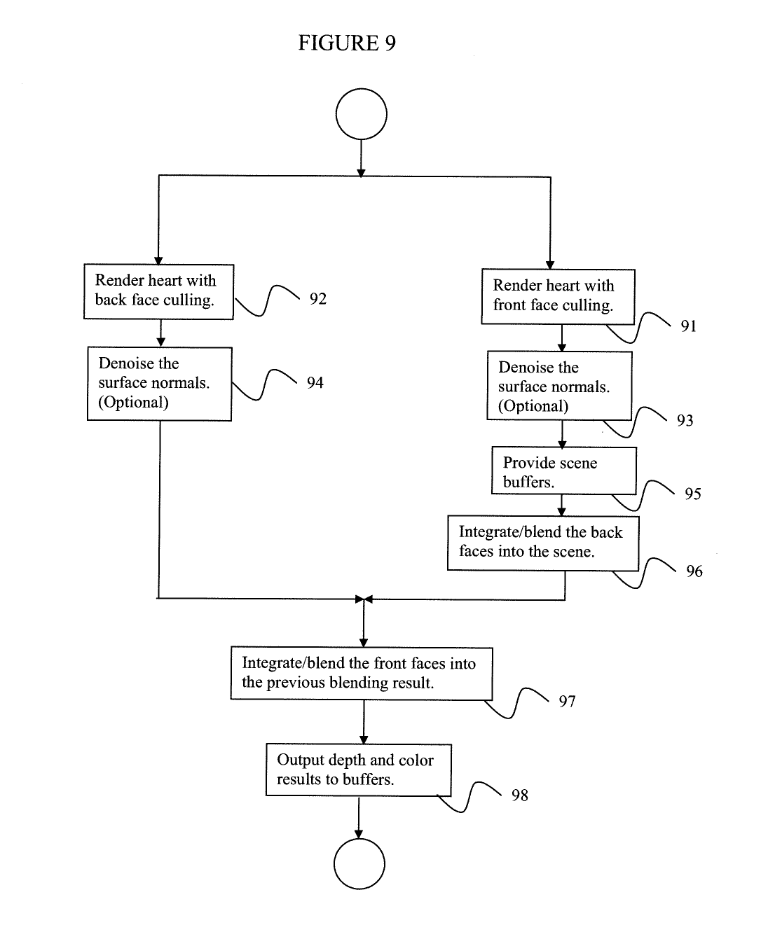

A culling peeling algorithm according to an embodiment of the invention includes two rendering passes of the transparent mesh, one with front face culling and the other with back face culling, and one blending pass can be used to avoid visualization artifacts. This technique essentially splits the mesh into 2 fragments, renders each separately before the blending passes. A flowchart of a method for simultaneously visualizing a transparent surface model at a selected view orientation with opaque objects, according to an embodiment of the invention is depicted in FIG. 9.

Referring now to FIG. 9, given a surface representation of an object, such as a surface mesh, a culling peeling algorithm according to an embodiment of the invention begins at steps 91 and 92 by rendering the object using back-face culling and front face culling, respectively. Front-face culling is rendering the object without showing the front face, so that one can see the inside of the back face. Similarly, back-face culling is rendering the object without showing the back face, so that one can see the front face.

According to an embodiment of the invention, the outputs of the front and back face culled renderings can include 2 buffers. One buffer is the dot product image of the real normal and the light direction for each point, and is used for shading. A second buffer is the dot product between the smoothed or real normal and the view direction, or carving direction if it is different from the view direction, and is used for the opacity computation (the carving). A third buffer is a depth buffer, which is used to match the rendered result with the scene in subsequent steps. However, in other embodiments of the invention, depending on settings, 2 buffers will suffice, if, for example, smoothed normals are not used or if the light direction equals the view direction.

At steps 93 and 94, the resulting surface normal values are denoised. The denoising steps are optional, and in other embodiments of the invention, these denoising steps may be omitted. At step 95, color and depth buffers of a rendered transparent surface model are provided, and using these buffers and the result of the front-face culling, the back faces of the object are integrated and blended into the transparent surface model at step 96 using one of the opacity models described above. The two rendering results are matched using the depth buffer output from the front face culled rendering. At step 97, result of the back-face culling is combined with the result of blending the back face into the transparent surface model, in which the front face is blended into the scene, again using one of the opacity models described above. The two rendering results are matched using the depth buffer output from the back face culled rendering. The results can be written to color and depth buffers at step 98. Shading can also be performed at the blending steps, steps 96 and 97.

### System Implementations

It is to be understood that embodiments of the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

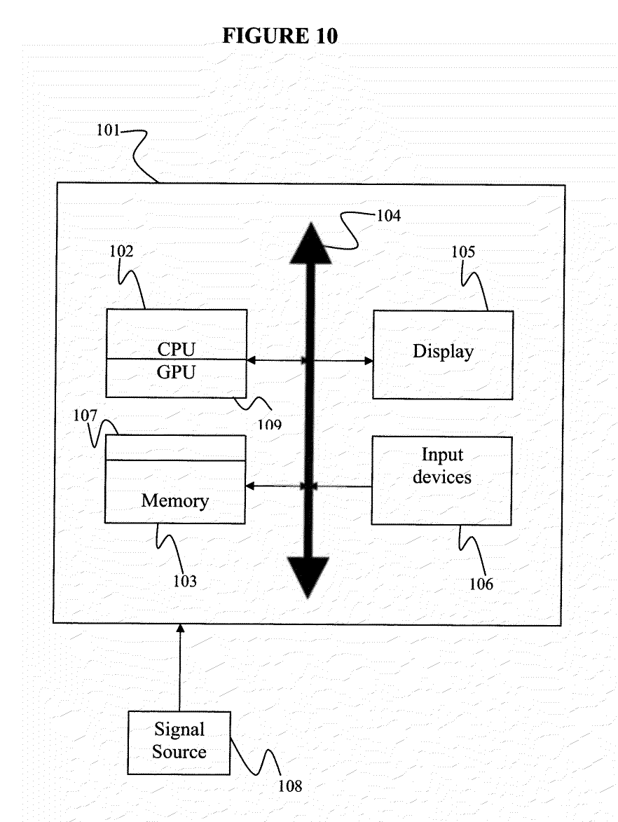

FIG. 10 is a block diagram of an exemplary computer system for implementing a a method for simultaneous visualization of the outside and the inside of a surface model at a selected view orientation according to an embodiment of the invention. Referring now to FIG. 10, a computer system 101 for implementing the present invention can comprise, inter alia, a central processing unit (CPU) 102, a graphics processing unit (GPU) 109, a memory 103 and an input/output (I/O) interface 104. The computer system 101 is generally coupled through the I/O interface 104 to a display 105 and various input devices 106 such as a mouse and a keyboard. The support circuits can include circuits such as cache, power supplies, clock circuits, and a communication bus. The memory 103 can include random access memory (RAM), read only memory (ROM), disk drive, tape drive, etc., or a combinations thereof. The present invention can be implemented as a routine 107 that is stored in memory 103 and executed by the CPU 102 or GPU 109 to process the signal from the signal source 108. As such, the computer system 101 is a general purpose computer system that becomes a specific purpose computer system when executing the routine 107 of the present invention.

The computer system 101 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

While the present invention has been described in detail with reference to exemplary embodiments, those skilled in the art will appreciate that various modifications and substitutions can be made thereto without departing from the spirit and scope of the invention as set forth in the appended claims.

What is claimed is:

1. A method for simultaneous visualization of the outside and the inside of a surface model at a selected carving orientation, the method comprising the steps of:
receiving a digitized representation of a surface of a segmented object, wherein said surface representation comprises a plurality of points;
receiving a selection of a carving direction for rendering said object;
calculating an inner product image by calculating an inner product \vec{n}ₚ·\vec{d} at each point on the surface mesh, wherein \vec{n}ₚ is a normalized vector representing the normal direction of the surface mesh at a point p towards the exterior of the object and \vec{d} is a normalized vector representing the carving direction; and
rendering said object using an opacity that is a function of said inner product image to yield a rendered object, wherein an interior of said object is rendered.

2. The method of claim 1, wherein said opacity is defined as
$$opacity ( p ) = \{ \begin{matrix}{{n}^{->}}_{p} \cdot {d}^{->} \leq c : 0 , \\ {{n}^{->}}_{p} \cdot {d}^{->} > c : 1 ,\end{matrix}$$
wherein c is a predetermined threshold that determines where the carving is performed on said surface.

3. The method of claim 1, wherein said opacity is defined as
$$opacity ( p ) = \{ \begin{matrix}1 , & if {{n}^{->}}_{p} \cdot {d}^{->} \leq 0 , \\ {clamp}_{[ 0 , 1 ]} [ 1 - α ( \frac{2 a sin ( {{n}^{->}}_{p} \cdot {d}^{->} )}{π} - c ) ] t , & otherwise ,\end{matrix}$$
wherein the clamp operator clamps opacity values to be between 0 and 1, c is a predetermined parameter that controls where transition between opaqueness and transparency starts, α is a predetermined parameter that controls the speed of change between opaque and fully transparent, and t is the opacity for the whole surface representation.

4. The method of claim 1, further comprising denoising said normal vectors of said surface representation by applying a low-pass filter to said inner product image.

5. The method of claim 1, further comprising:
registering said rendered object to a patient;
receiving a 2D image of said object from said patient;
overlaying rendered object onto said 2D image of said object; and
displaying said overlaid image.

6. The method of claim 1, wherein said surface is represented as a triangular mesh.

7. The method of claim 1, wherein the carving direction is a view direction.

8. A method for simultaneous visualization of the outside and the inside of a surface model at a selected carving orientation, the method comprising the steps of:
receiving a digitized representation of a surface of a segmented object, wherein said surface representation comprises a plurality of points;
calculating \vec{n}ₚ·\vec{d} at each point on a front of said surface representation to yield a back face culled inner product image, wherein \vec{n}ₚ is a normalized vector representing the normal direction of the surface representation at a point p towards the exterior of the object and \vec{d} is a normalized vector representing a carving direction;
calculating \vec{n}ₚ·\vec{d} and a depth at each point on a back of said surface representation to yield a front face culled inner product image and a front face depth;
receiving a color buffer and a depth buffer of a rendered scene;
blending said back face culled inner product image with said rendered scene using said opacity function to yield a partially blended scene; and
blending said front face culled inner product image with said partially blended scene using said opacity function to yield a fully blended scene.

9. The method of claim 8, further comprising:
calculating a depth at each point on the front of said surface representation to yield a back face depth;
using said back face depth to match said back face culled inner product image to said rendered scene;
calculating a depth at each point on the back of said surface representation to yield a front face depth; and
using said front face depth to match said front face culled inner product image to said partially blended scene.

10. The method of claim 8, wherein said back face is colored with a first color when it is blended with said scene, and said front face is colored with a second color when it is blended with said scene.

11. The method of claim 8, wherein said opacity is defined as
$$opacity ( p ) = \{ \begin{matrix}{{n}^{->}}_{p} \cdot {d}^{->} \leq c : 0 , \\ {{n}^{->}}_{p} \cdot {d}^{->} > c : 1 ,\end{matrix}$$
wherein c is a predetermined threshold that determines where the carving is performed on said surface.

12. The method of claim 8, wherein said opacity is defined as
$$opacity ( p ) = \{ \begin{matrix}1 , & if {{n}^{->}}_{p} \cdot {d}^{->} \leq 0 , \\ {clamp}_{[ 0 , 1 ]} [ 1 - α ( \frac{2 a sin ( {{n}^{->}}_{p} \cdot {d}^{->} )}{π} - c ) ] t , & otherwise ,\end{matrix}$$
wherein the clamp operator clamps opacity values to be between 0 and 1, c is a predetermined parameter that controls where transition between opaqueness and transparency starts, α is a predetermined parameter that controls the speed of change between opaque and fully transparent, and t is a global opacity.

13. The method of claim 8, wherein the carving direction is a view direction.

14. A program storage device readable by a computer, tangibly embodying a program of instructions executable by the computer to perform the method steps for simultaneous visualization of the outside and the inside of a surface model at a selected carving orientation, the method comprising the steps of:
receiving a digitized representation of a surface of a segmented object, wherein said surface representation comprises a plurality of points;
receiving a selection of a carving direction for rendering said object;
calculating an inner product image by calculating an inner product \vec{n}ₚ·\vec{d} at each point on the surface mesh, wherein \vec{n}ₚ is a normalized vector representing the normal direction of the surface mesh at a point p towards the exterior of the object and \vec{d} is a normalized vector representing the carving direction; and
rendering said object using an opacity that is a function of said inner product image to yield a rendered object, wherein an interior of said object is rendered.

15. The computer readable program storage device of claim 14, wherein said opacity is defined as
$$opacity ( p ) = \{ \begin{matrix}{{n}^{->}}_{p} \cdot {d}^{->} \leq c : 0 , \\ {{n}^{->}}_{p} \cdot {d}^{->} > c : 1 ,\end{matrix}$$
wherein c is a predetermined threshold that determines where the carving is performed on said surface.

16. The computer readable program storage device of claim 14, wherein said opacity is defined as
$$opacity ( p ) = \{ \begin{matrix}1 , & if {{n}^{->}}_{p} \cdot {d}^{->} \leq 0 , \\ {clamp}_{[ 0 , 1 ]} [ 1 - α ( \frac{2 a sin ( {{n}^{->}}_{p} \cdot {d}^{->} )}{π} - c ) ] t , & otherwise ,\end{matrix}$$
wherein the clamp operator clamps opacity values to be between 0 and 1, c is a predetermined parameter that controls where transition between opaqueness and transparency starts, α is a predetermined parameter that controls the speed of change between opaque and fully transparent, and t is the opacity for the whole surface representation.

17. The computer readable program storage device of claim 14, the method further comprising denoising said normal vectors of said surface representation by applying a low-pass filter to said inner product image.

18. The computer readable program storage device of claim 14, the method further comprising:
registering said rendered object to a patient;
receiving a 2D image of said object from said patient;
overlaying rendered object onto said 2D image of said object; and
displaying said overlaid image.

19. The computer readable program storage device of claim 14, wherein said surface is represented as a triangular mesh.

20. The computer readable program storage device of claim 14, wherein the carving direction is a view direction.
